(19) United States
(12) Patent Application Publication
(10) Pub. No.: US 2025/0315925 A1
(43) Pub. Date: Oct. 9, 2025

(54) METHOD AND SYSTEM OF HUE-DISTANCE CONSTRAINED RELATIVE RADIOMETRIC CORRECTION CONSIDERING H-K EFFECT FOR REMOTE SENSING IMAGES

(71) Applicant: WUHAN UNIVERSITY, Hubei (CN)

(72) Inventors: Jun PAN, Hubei (CN); Yuchuan BAI, Hubei (CN); Mi WANG, Hubei (CN)

(73) Assignee: WUHAN UNIVERSITY, Hubei (CN)

(21) Appl. No.: 19/087,569

(22) Filed: Mar. 23, 2025

(30) Foreign Application Priority Data
Apr. 7, 2024 (CN) 202410405394.2

(51) Int. Cl. G06T 5/70; G06T 7/90

(52) U.S. Cl. CPC G06T 5/70; G06T 7/90; G06T 2207/10024; G06T 2207/10036; G06T 2207/20048; G06T 2207/20182

(57) ABSTRACT

This disclosure discloses a method and system of hue-distance constrained relative radiometric correction considering Helmholtz-Kohlrausch (H-K) effect for multiple remote sensing images. The method comprises: first converting the image from the RGB color space to the CIELAB color space, then performing relative radiometric correction using adaptive constraint based on hue-distance, and quantitatively describing the H-K effect to apply global lightness mapping to the corrected image. Based on the limitations of the RGB color space, this disclosure proposes a relative radiometric correction strategy that maintains hue distance, which suppresses radiometric anomalies in local regions and optimizes correction results. By implementing global lightness mapping based on the H-K effect and introducing perceived lightness into the relative radiometric correction of remote sensing images, this method effectively enhances the radiation consistency of multi-temporal images.

### CROSS-REFERENCE TO RELATED APPLICATIONS

Pursuant to 35 U.S.C. § 119 and the Paris Convention Treaty, this application claims foreign priority to Chinese Patent Application No. 202410405394.2 filed Apr. 7, 2024, the contents of which, including any intervening amendments thereto, are incorporated herein by reference.

### BACKGROUND

### Technical Field

The disclosure relates to the field of remote sensing image processing and analysis, and more particularly to a method of hue-distance constrained relative radiometric correction considering the H-K effect for multiple remote sensing images of different shooting times.

In the field of remote sensing satellite imaging, the propagation of electromagnetic waves is influenced by atmospheric conditions, which can result in varying degrees of distortion. Additionally, the reflectance characteristics of surface features exhibit significant variations under different spatiotemporal conditions. These imaging conditions, coupled with the complexity of surface features, often lead to noticeable radiance discrepancies in remote sensing images acquired at different times. Such discrepancies severely impact the generation of orthophoto products and the extraction of information from remote sensing images. Therefore, there is an urgent need to eliminate radiance discrepancies between remote sensing images captured at different times and across varying spatial extents, and to achieve efficient relative radiometric correction of remote sensing images.

Existing relative radiometric correction methods can generally be divided into two categories: statistical-based methods and mathematical model-based methods. Statistical-based methods assume that images with consistent radiation should exhibit consistency in their statistical properties. These methods first calculate the statistical properties of a reference image or the entire image dataset, and then make detailed adjustments to individual input images based on these statistical foundations. Mathematical model-based methods typically select one or more visually representative regions as reference points. A linear or nonlinear mathematical model is created in the pseudo-invariant areas where the reference image and target image overlap. By solving these models, the correction parameters for the target image are derived and used to correct the image. However, most existing mathematical model-based methods require the pre-selection of one or more reference images, and there is no standard method for selection. When the overlapping area between two images is small and the radiometric differences are large, linear or nonlinear models fail to accurately describe the transformation relationship between the images. Furthermore, path propagation-based methods inevitably lead to error accumulation, especially when the image dataset is large. In such cases, the correction effect may not be ideal. Additionally, when there are significant radiometric differences between images, correcting each RGB channel individually may result in anomalous radiometric values in the corrected images.

### SUMMARY

To address the limitations of existing technologies, the disclosure provides a method of hue-distance constrained relative radiometric correction considering the Helmholtz-Kohlrausch (H-K) effect. In order to tackle potential radiometric anomalies in relative radiometric correction, this method decouples pixel radiometric values through color space transformations, minimizing channel correlations, and the correction process is adaptively constrained using hue distance to suppress the occurrence of anomalous radiometric values. Taking the H-K effect into account, the method employs the concept of global lightness mapping to eliminate the discrepancy between perceived lightness and physical lightness, thereby achieving a correction result that better aligns with human visual perception.

The disclosure provides a method of hue-distance constrained relative radiometric correction considering Helmholtz-Kohlrausch (H-K) effect for remote sensing image, comprising:
step 1, converting an image from a RGB color space to a CIELAB color space and performing a relative radiometric correction using an adaptive constraint based on hue-distance;
step 1.1, converting the image from the RGB color space to the CIELAB color space with luminance-chroma separation, decoupling of pixel radiometric values through transformation between color spaces to minimize channel correlation;
step 1.2, performing the relative radiometric correction using the adaptive constraint based on the hue-distance
step 2, quantitatively describing the H-K effect and applying global lightness mapping to a corrected image;
step 2.1, converting the corrected image after relative radiometric correction into the CIELAB color space;
step 2.2, calculating perceived lightness of the image based on the H-K effect;
step 2.3, based on the perceived lightness calculated in step 2.2, establishing a relationship between physical lightness and the perceived lightness, and performing global lightness mapping on the corrected image.

Furthermore, in the step 1.1, RGB values of pixels are first converted to linear RGB values, then the linear RGB values are converted to a CIEXYZ color space, and finally values of the pixel points in the CIEXYZ color space are converted to the CIELAB color space. The specific conversion formula is as follows:

$${R}_{l i n e a r} = {( \frac{R}{255} )}^{γ i n v e r s e} \qquad ( 1 )$$

$${G}_{l i n e a r} = {( \frac{G}{255} )}^{γ i n v e r s e} \qquad ( 2 )$$

$${B}_{l i n e a r} = {( \frac{B}{255} )}^{γ i n v e r s e} \qquad ( 3 )$$

Where R, G, B are the values of the pixel point in RGB color space, Rₗᵢₙₑₐᵣ, Gₗᵢₙₑₐᵣ, Bₗᵢₙₑₐᵣ are the RGB values of the pixel point after linearization, γᵢₙᵥₑᵣₛₑ is the inverse operation of the gamma correction, calculated as the usual 2.2 gamma correction.

Converts linear RGB to CIEXYZ color space;

$$[ \begin{matrix}X \\ Y \\ Z\end{matrix} ] = [ \begin{matrix}0.4124564 & 0.3575761 & 0.1804375 \\ 0.2126729 & 0.7151522 & 0.072175 \\ 0.0193339 & 0.119192 & 0.9503041\end{matrix} ] \times [ \begin{matrix}{R}_{l i n e a r} \\ {G}_{l i n e a r} \\ {B}_{l i n e a r}\end{matrix} ] \qquad ( 4 )$$

Where X, Y, Z are the values of the pixel point in CIEXYZ color space, Rₗᵢₙₑₐᵣ, Gₗᵢₙₑₐᵣ, Bₗᵢₙₑₐᵣ are the RGB values of the pixel point after linearization.

Converts XYZ values to CIELAB color space.

$${L}^{*} = 116 \times f ( \frac{Y}{{Y}_{n}} ) - 16 \qquad ( 5 )$$

$${a}^{*} = 500 \times ( f ( \frac{X}{{X}_{n}} ) - f ( \frac{Y}{{Y}_{n}} ) ) \qquad ( 6 )$$

$${b}^{*} = 200 \times ( f ( \frac{Y}{{Y}_{n}} ) - f ( \frac{Z}{{Z}_{n}} ) ) \qquad ( 7 )$$

Where L*, a*, b* are the values of the pixel point in CIELAB color space, X, Y, Z are the values of the pixel point in CIEXYZ color space, Xₙ, Yₙ, Zₙ represent the XYZ values of the white point. If t>0.008856, f(t)=t^{1/3}, otherwise f(t)=16×t/903.3.

Furthermore, in the step 1.2, the image converted to the CIELAB color space is pre-corrected once using the Wallis transformation.

$$wallis ( g ( x , y ) ) = \frac{{σ}_{t}}{c {σ}_{s} + ( 1 - c ) {σ}_{t}} [ g ( x , y ) - {μ}_{s} ] + b {μ}_{t} + ( 1 - b ) {μ}_{s} \qquad ( 8 )$$

In the formula, g(x, y) represents the pixel grayscale value of the image to be processed after converting to the CIELAB color space; σₛ denotes the standard deviation of the pixel grayscale values in the image to be processed in the CIELAB color space; σₜ represents the standard deviation of the pixel grayscale values in the ideally corrected result image; μₛ refers to the mean grayscale value of the pixels in the image to be processed in the CIELAB color space; μₜ represents the mean grayscale value of the pixels in the ideally corrected result image; b is the luminance coefficient, where b∈(0,1); c is the variance expansion coefficient, where c∈(0,1); and wallis denotes the Wallis transform.

Furthermore, in the step 1.2, an image to be processed in the CIELAB color space and pre-corrected image are converted to a HSV color space, for each pixel to be processed, an initial hue h₀, an average hue of all pixels to be processed h̅₀, a result hue h₁ of each pre-corrected pixel, and an average hue of all pre-corrected pixels h̅₁ are calculated, hue values are expressed in degrees.
the calculation is performed as follows:

$$h = \{ \begin{matrix}0 ° , else \\ 60 ° \times \frac{g - b}{max - min} , if max = r and g \geq b \\ 60 ° \times \frac{g - b}{max - min} + 360 ° , if max = r and g < b \\ 60 ° \times \frac{b - r}{max - min} + 120 ° , if max = g \\ 60 ° \times \frac{r - g}{max - min} + 240 ° , if max = b\end{matrix} \qquad ( 9 )$$

where h is the hue, (r, g, b) is the r, g, b value of the corresponding pixel, max is the maximum value in (r, g, b) and min is the minimum value in (r, g, b).

Furthermore, in the step 1.2, a hue-distance Dₕ for each pixel before pre-correction and a hue-distance Dₕ′ for each pixel after pre-correction, if |Dₕ′-Dₕ| is lower than a set threshold of hue distance change, then a corresponding pixel is corrected using the adaptive constraint in the CIELAB color space and saved in RGB format.

$${D}_{h} = {h}_{0} - \overline{h} \qquad ( 10 )$$

$${D}_{h}^{′} = {h}_{1} - \overline{{h}_{1}} \qquad ( 11 )$$

If |Dₕ′-Dₕ|≤ε, ε is the set threshold of hue distance change, then adaptive constraint correction is performed on the pixel in the CIELAB color space and saved in RGB format, and the specific formula for adaptive constraint correction is as follows:

$$Conwallis ( g ( x , y ) ) = \frac{{σ}_{t} \times \frac{ω {D}_{h}}{{D}_{h}^{′}}}{c {σ}_{s} + ( 1 - c ) {σ}_{t}} [ g ( x , y ) - {μ}_{s} ] + b {μ}_{t} + ( 1 - b ) {μ}_{s} \qquad ( 12 )$$

In the formula, g(x, y) represents the grayscale value of the pixels in the pre-corrected result image; σₛ denotes the standard deviation of the pixel grayscale values in the pre-corrected result image; when a reference image is available, σₜ represents the standard deviation of the reference image; when no reference image is available, σₜ is the average standard deviation of all the pixels in the image to be processed; μₛ represents the mean grayscale value of the pixels in the pre-corrected result image; when a reference image is available, μₜ represents the mean value of the reference image; when no reference image is available, μₜ is the average mean value of all the pixels in the image to be processed; b is the luminance coefficient, where b∈(0,1); c is the variance expansion coefficient, where c∈(0,1); Conwallis represents the constrained Wallis transform; ω is the constraint coefficient; Dₕ represents the hue distance before pre-correction, and Dₕ′ represents the hue distance after pre-correction.

Furthermore, in the step 2.1, RGB image corrected by the adaptive constraint in step 1.2 is converted to the CIELAB color space, and a specific conversion method is the same as in step 1.1.

Furthermore, in step 2.2, a calculation model for the perceived lightness is built.

$$P L = {L}^{*} + ( 2.5 - 0.025 {L}^{*} ) q ( h ) {C}^{*} \qquad ( 13 )$$

$$q ( h ) = 0 \text{.116} \vert sin ( \frac{h - 90}{2} ) \vert + 0.085 \qquad ( 14 )$$

$${C}^{*} = \sqrt{{( {a}^{*} )}^{2} + {( {b}^{*} )}^{2}} \qquad ( 15 )$$

$$h = {tan}^{- 1} ( \frac{{b}^{*}}{{a}^{*}} ) \qquad ( 16 )$$

Where L*, a*, b* are the values of the pixel point in CIELAB color space, PL denotes perceived lightness and the difference between PL and L* is proportional to C* when L* and h are constant. Even if the lightness remains constant, the perceived lightness of the human eye decreases as the chromaticity decreases.

Furthermore, in step 2.3, the calculation model for the perceived lightness is used to compute the perceived lightness of each pixel in the image to be mapped and a lightness reference image, perceived lightness means μ_{PL}^{ori}, μ_{PL}^{ref} and standard deviations σ_{PL}^{ori}, σ_{PL}^{ref} for the image to be mapped and the lightness reference image are obtained by calculating, a new lightness L*_{new} is obtained by global lightness mapping via the Wallis transformation, and the image after lightness update is converted from CIELAB color space to the RGB color space.

The specific calculation formulas are as follows:

$$μ = \frac{{\sum }_{i = 1 , j = 1}^{I , J} P {L}_{i j}}{I \times J} \qquad ( 17 )$$

$$σ = \sqrt{\frac{{\sum }_{i = 1 , j = 1}^{I , J} {( P {L}_{i j} - μ )}^{2}}{I \times J}} \qquad ( 18 )$$

Where, I, J denote the width and height of the image, PLᵢⱼ denotes the perceived lightness of the image.

$$P {L}_{r e s} = \frac{{σ}_{P L}^{ref}}{c {σ}_{P L}^{o r i} + ( 1 - c ) {σ}_{P L}^{r e f}} [ P {L}_{o r i} - {μ}_{P L}^{o r i} ] + b {μ}_{P L}^{r e f} + ( 1 - b ) {μ}_{P L}^{o r i} \qquad ( 19 )$$

$${L}_{n e w}^{*} = \frac{( P {L}_{r e s} - 2.5 q ( h ) {C}^{*} )}{( 1 - 0.025 q ( h ) {C}^{*} )} \qquad ( 20 )$$

Where, PLᵣₑₛ is the perceived lightness of the pixel after mapping, PLₒᵣᵢ is the original perceived lightness of the pixel, b is the lightness coefficient, b∈(0,1); c is the variance expansion coefficient, c∈(0,1).

The disclosure provides a system of hue-distance constrained relative radiometric correction considering H-K effect for remote sensing images, characterized by comprising a processor and a memory, wherein the memory is configured to store program instructions, and the processor is configured to call the program instructions in the memory to execute the method of hue-distance constrained relative radiometric correction considering H-K effect for remote sensing images according to claim 1.

The disclosure provides a system of hue-distance constrained relative radiometric correction considering H-K effect for remote sensing images, characterized by comprising a readable storage medium, wherein the readable storage medium has a computer program stored thereon, the computer program, when executed, realizes the method of hue-distance constrained relative radiometric correction considering H-K effect for remote sensing images.

Compared with existing technologies, the disclosure has the following advantages. 1) A new strategy for suppressing radiometric anomalies: Due to the limitations of the RGB color space, remote sensing images with significant radiometric differences can easily exhibit anomalous radiometric values in localized regions of the correction result, which severely impacts the generation of remote sensing image products and subsequent information extraction. The disclosure, based on the limitations of the RGB color space, proposes a relative radiometric correction strategy that accounts for hue distance preservation, effectively suppressing radiometric anomalies in localized regions and optimizing the correction result.

2) A new application of the H-K effect: The H-K effect suggests that the perceived lightness is closely related to color, a factor often overlooked in relative radiometric correction of remote sensing images. The disclosure incorporates the H-K effect by implementing global lightness mapping, introducing perceived lightness into the relative radiometric correction of remote sensing images.

3) An effective new method for reference-free relative radiometric correction: Some existing remote sensing image correction methods typically require the selection of an appropriate reference image to achieve correction. However, due to limitations in the imaging area, processing environment, and selection criteria, it is challenging to ensure the quality of the acquired reference image, or in some cases, obtaining a reference image may not even be possible. This significantly limits the usability of correction algorithms. The disclosure achieves satisfactory correction results even in the absence of a reference image, providing a new approach and alternative for relative radiometric correction of multiple remote sensing images.

### BRIEF DESCRIPTION OF THE DRAWINGS

FIG. 1 is a flowchart of the method of hue-distance constrained relative radiometric correction considering the H-K effect.

FIG. 2 is a flowchart of the correction process using an adaptive constraint based on hue-distance.

FIG. 3 shows the change of hue when the values of the green-blue components are fixed and the red component varies from small to large.

FIG. 4 is a flowchart of global lightness mapping considering the H-K effect.

FIGS. 5A to 5F show the results of the visual assessment of the example for the correction workflow. The lower left corner of each result map shows an area prone to abnormal radiance results, and the lower right corner shows the seam area of six of the images.

### DESCRIPTION OF THE EMBODIMENTS

To make the objectives, technical solutions, and advantages of the disclosure clearer, the following detailed description will be made with reference to the accompanying drawings and embodiments of the disclosure. It is evident that the described embodiments are part of the embodiments of the disclosure, but not all of them. All other embodiments that can be derived by a person skilled in the art, without making any creative efforts, based on the embodiments of the disclosure, are within the scope of protection of the disclosure.

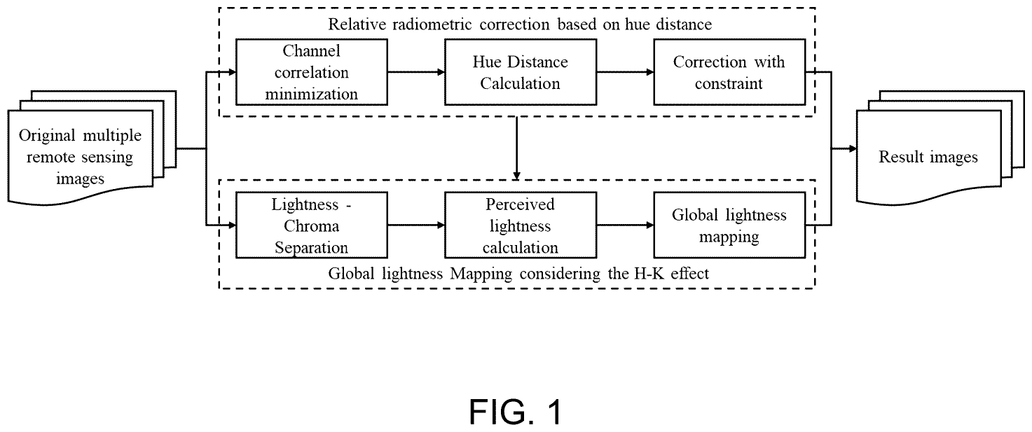

As shown in FIG. 1, the method is delineated into two primary components: relative radiometric correction based on hue-distance constraint and global lightness mapping considering the H-K effect.

In step 1, the image from the RGB color space to the CIELAB color space is converted and relative radiometric correction is performed using an adaptive constraint based on hue distance-based.

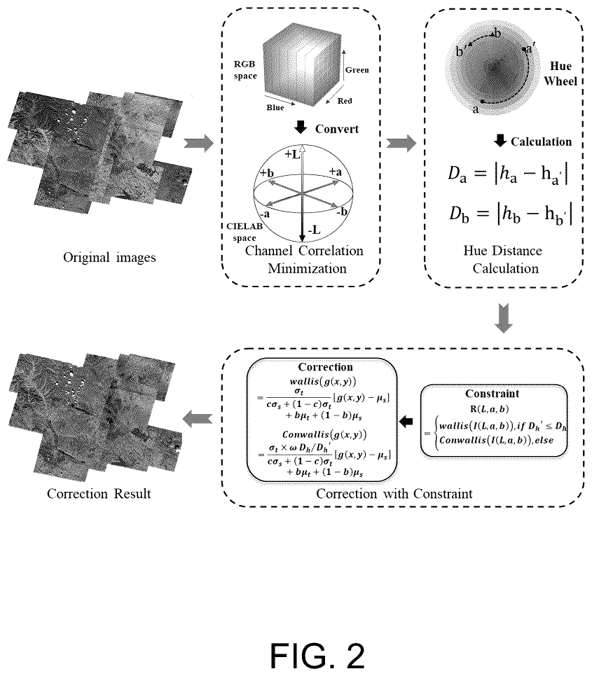

As shown in FIG. 2, to address the issue of radiometric anomalies that may arise from RGB-based correction methods, the method proposed in this disclosure minimizes channel correlations and employs hue distance to adaptively constrain the correction process, thereby suppressing the occurrence of abnormal radiometric values. For a given original image, the proposed method decouples pixel radiometric values through color space transformation, calculates the hue-distance to obtain the constraint conditions, and finally optimizes the correction process using these constraints to produce the resulting image.

In step 1.1, the image is converted from the RGB color space to the CIELAB color space with luminance-chroma separation, pixel radiometric values is decoupled through the transformation between color spaces to minimize channel correlations and overcom the limitations of the RGB color space.

First, RGB values of pixels are converted to linear RGB, and the specific conversion formula is as follows:

$${R}_{l i n e a r} = {( \frac{R}{255} )}^{γ inverse} \qquad ( 21 )$$

$${G}_{l i n e a r} = {( \frac{G}{255} )}^{γ inverse} \qquad ( 22 )$$

$${B}_{l i n e a r} = {( \frac{B}{255} )}^{γ inverse} \qquad ( 23 )$$

Where R, G, B are the values of the pixel point in RGB color space, Rₗᵢₙₑₐᵣ, Gₗᵢₙₑₐᵣ, Bₗᵢₙₑₐᵣ are the RGB values of the pixel point after linearization, γᵢₙᵥₑᵣₛₑ is the inverse operation of the gamma correction, 2.2 gamma correction is used during calculation in the embodiment.

Then, the linear RGB values are converted to CIEXYZ color space, that is:

$$[ \begin{matrix}X \\ Y \\ Z\end{matrix} ] = [ \begin{matrix}0.4 \; 124564 & 0.3575761 & 0.180 \; 4375 \\ 0.2126729 & 0.7151522 & 0.0721750 \\ 0.0193339 & 0.1191920 & 0.9503041\end{matrix} ] \times [ \begin{matrix}{R}_{line a r} \\ {G}_{line a r} \\ {B}_{line a r}\end{matrix} ] \qquad ( 24 )$$

Where X, Y, Z are the values of the pixel point in CIEXYZ color space, Rₗᵢₙₑₐᵣ, Gₗᵢₙₑₐᵣ, Bₗᵢₙₑₐᵣ are the RGB values of the pixel point after linearization.

Finally, values of the pixel points in the CIEXYZ color space are converted to CIELAB color space, that is:

$${L}^{*} = 116 \times f ( \frac{Y}{{Y}_{n}} ) - 16 \qquad ( 25 )$$

$${a}^{*} = 500 \times ( f ( \frac{X}{{X}_{n}} ) - f ( \frac{Y}{{Y}_{n}} ) ) \qquad ( 26 )$$

$${b}^{*} = 200 \times ( f ( \frac{Y}{{Y}_{n}} ) - f ( \frac{Z}{{Z}_{n}} ) ) \qquad ( 27 )$$

Where L*, a*, b* are the values of the pixel point in CIELAB color space, X, Y, Z are the values of the pixel point in CIEXYZ color space, Xₙ, Yₙ, Zₙ represent the XYZ values of the white point. If t>0.008856, f(t)=t^{1/3}, otherwise f(t)=16×t/903.3.

In step 1.2, the relative radiometric correction is performed using the adaptive constraint based on the hue-distance.

Radiance anomalies are probable phenomena in relative radiometric correction. The method of using the Wallis transform to achieve relative radiometric correction is essentially to add certain fluctuations to the grey scale mean value to achieve the approximation of the whole probability distribution. In this process, the magnitude of the change in the gray scale value of the original image often depends on the relationship between the variance magnitude of the original image and the target image, and the magnitude of the change in the gray scale value of the original image will be greater when the difference in the variance between the two is larger.

When processing remote sensing images, people always hope that the processed image will obtain a smaller variance similar to the target image while keeping the detailed information of the original image as much as possible. Taking the grey scale mean value as the benchmark, when the change in gray scale value causes a change in the magnitude relationship between the three RGB color components, the chroma information will change at the same time. The greater the change in grayscale value, the greater the change in chroma information, the more likely the radiance anomalies will appear.

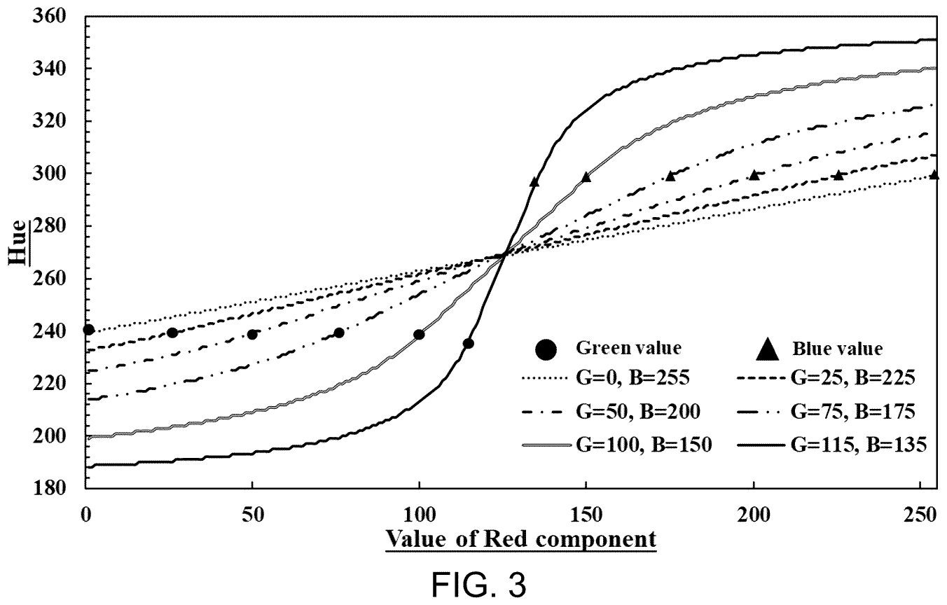

FIG. 3 shows the change of hue when the values of the green-blue components are fixed and the red component varies from small to large. The hue change curve is similar to an arctangent function, and the larger the difference between the green-blue components is, the smaller the range of hue change is, and the speed of hue change increases when the value of the red component varies near the green-blue component. This suggests that the relationship between the magnitude of the RGB color components can cause drastic changes in hue.

In most cases, relative radiometric correction in RGB color space can achieve good results, but when the radiance differences between multiple remote sensing images are large, the processing results are likely to have radiance anomalies locally. To address this problem, an adaptive constraint is added to the correction process, which can adaptively adjust the magnitude of the change of the gray scale value of the original image by accurately measuring the radiance difference between the original image and the target image, so as to inhibit the appearance of abnormal radiance as much as possible, and make the processed image have a more uniform color.

Since the uniformity of RGB color space is poor and cannot accurately measure the radiance differences, the proposed adaptive constraint method adopts the H channel of HSV color space as a way to measure the radiometric differences. Compared to the RGB color space, the representation of color in HSV color space is easier to understand and can facilitate meaningful radiometric differences. In HSV space, chroma information is concentrated in H channel, which facilitates the measurement of radiance differences. Hue-distance means the difference between the chroma of a point on an image and the average chroma. When the base chroma of multiple images is unified, a more natural correction result can be obtained by keeping the hue-distance from changing drastically before and after correction.

For the image converted to CIELAB color space in step 1.1, a pre-correction is first performed using the Wallis transform, calculated as:

$$wallis ( g ( x , y ) ) = \frac{{σ}_{t}}{c {σ}_{s} + ( 1 - c ) {σ}_{t}} [ g ( x , y ) - {μ}_{s} ] + b {μ}_{t} + ( 1 - b ) {μ}_{s} \qquad ( 28 )$$

In the formula, g(x, y) represents the pixel gray scale value of the image to be processed after converting to the CIELAB color space; σₛ denotes the standard deviation of the pixel gray scale values in the image to be processed in the CIELAB color space; when a reference image is available, σₜ represents the standard deviation of the pixel gray scale values in the reference image; when no reference image is available, σₜ represents an average of multiple standard deviations of all the pixels in the image to be processed; μₛ refers to the grey scale mean value of the pixels in the image to be processed in the CIELAB color space; when a reference image is available, μₜ represents the gray scale mean value of the pixels in the reference image; when no reference image is available, μₜ represents an average of multiple the gray scale mean values of all the pixels in the image to be processed; b is the luminance coefficient, where b∈(0,1); c is the variance expansion coefficient, where c∈(0,1); wallis denotes the Wallis transformation.

The image to be processed in the CIELAB color space and the pre-corrected result image are converted to the HSV color space. For each pixel to be processed, the initial hue h₀, the average hue of all the pixels to be processed h̅₀̅, the result hue h₁ of each pre-corrected pixel, and the average hue of all pre-corrected pixels h̅₁̅ are calculated. The hue values are expressed in degrees, and the calculation is performed as follows:

$$h = \{ \begin{matrix}0 ° , else \\ 60 ° \times \frac{g - b}{max - min} , if max = r and g \geq b \\ 60 ° \times \frac{g - b}{max - min} + 360 ° , if max = r and g < b \\ 60 ° \times \frac{b - r}{max - min} + 120 ° , if max = g \\ 60 ° \times \frac{r - g}{max - min} + 240 ° , if max = b\end{matrix} \qquad ( 29 )$$

Where h is the hue, (r, g, b) is the r, g, b value of the corresponding pixel, max is the maximum value in (r, g, b) and min is the minimum value in (r, g, b).

A hue-distance Dₕ for each pixel before pre-correction and a hue-distance Dₕ′ for each pixel after pre-correction are obtain, that is:

$${D}_{h} = {h}_{0} - \overline{h} \qquad ( 30 )$$

$${D}_{h}^{′} = {h}_{1} - \overline{{h}_{1}} \qquad ( 31 )$$

If |Dₕ′−Dₕ|≤ε, ε is the set threshold of hue distance change, then the corresponding pixel is corrected using the adaptive constraint in the CIELAB color space and saved in RGB format, and the specific formula for the correction of the adaptive constraint is as follows:

$$Conwallis ( g ( x , y ) ) = \frac{{σ}_{t} \times \frac{ω {D}_{h}}{{D}_{h}^{′}}}{c {σ}_{s} + ( 1 - c ) {σ}_{t}} [ g ( x , y ) - {μ}_{s} ] + b {μ}_{t} + ( 1 - b ) {μ}_{s} \qquad ( 32 )$$

In the formula, g(x, y) represents the pixel gray scale value of the pre-corrected result image; σₛ denotes the standard deviation of the pixel gray scale values in the pre-corrected result image; when a reference image is available, σₜ represents the standard deviation of the pixel gray scale values in the reference image; when no reference image is available, σₜ represents an average of multiple standard deviations of all the pixels in the image to be processed; μₛ represents the grey scale mean value of the pixels in the pre-corrected result image; when a reference image is available, μₜ represents the gray scale mean value of the pixels in the reference image; when no reference image is available, μₜ represents an average of multiple the gray scale mean values of all the pixels in the image to be processed; b is the luminance coefficient, where b∈(0,1); c is the variance expansion coefficient, where c∈(0,1); Conwallis represents the constrained Wallis transformation; ω is the constraint coefficient; Dₕ represents the hue distance before pre-correction, and Dₕ′ represents the hue distance after pre-correction.

In step 2, the H-K effect is quantitatively described and global lightness mapping is applied to the corrected image.

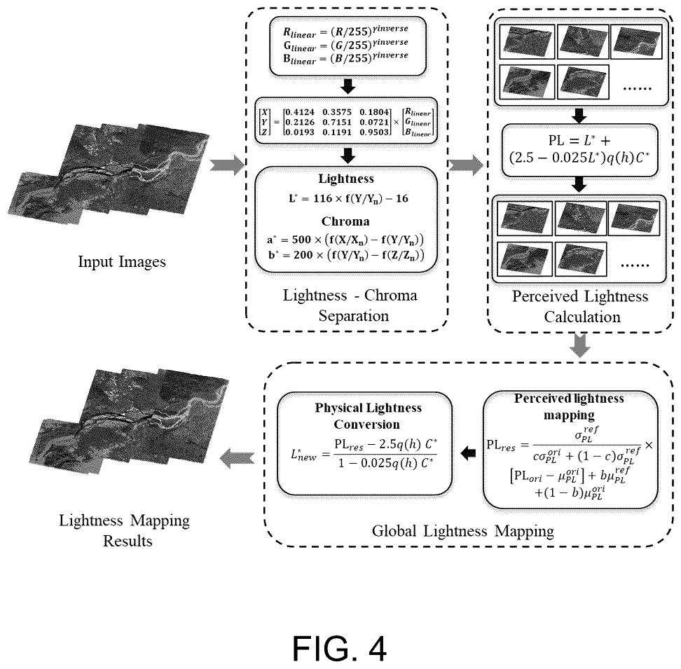

As shown in FIG. 4, the H-K effect in relative radiometric correction manifests as the difference between the physical lightness and perceived lightness of the image, which is often overlooked in remote sensing image processing. This disclosure employs the concept of global lightness mapping to eliminate this discrepancy and extends the perceived lightness mapping from the pixel level to the image level. For a given input image, this disclosure first decomposes the radiation value into lightness and chroma, introduces the human eye's subjective visual perception through the H-K effect, calculates the perceived lightness, and finally applies the Wallis formula to achieve global lightness mapping.

In step 2.1, the corrected RGB image is converted into the CIELAB color space, which facilitates the modelling of the relationship between physical and perceived lightness.

RGB values of pixels are first converted to linear RGB, and the specific conversion formula is as follows:

$${R}_{l i n e a r} = {( \frac{R}{255} )}^{γ inverse} \qquad ( 33 )$$

$${G}_{l i n e a r} = {( \frac{G}{255} )}^{γ inverse} \qquad ( 34 )$$

$${B}_{l i n e a r} = {( \frac{B}{255} )}^{γ inverse} \qquad ( 35 )$$

Where R, G, B are the values of the pixel point in RGB color space, Rₗᵢₙₑₐᵣ, Gₗᵢₙₑₐᵣ, Bₗᵢₙₑₐᵣ are the RGB values of the pixel point after linearization, γᵢₙᵥₑᵣₛₑ is the inverse operation of the gamma correction, 2.2 gamma correction is used during calculation in the embodiment.

Then, the linear RGB values are converted to CIEXYZ color space, that is:

$$[ \begin{matrix}X \\ Y \\ Z\end{matrix} ] = [ \begin{matrix}0.4 \; 124564 & 0.3575761 & 0.180 \; 4375 \\ 0.2126729 & 0.7151522 & 0.0721750 \\ 0.0193339 & 0.1191920 & 0.9503041\end{matrix} ] \times [ \begin{matrix}{R}_{line a r} \\ {G}_{line a r} \\ {B}_{line a r}\end{matrix} ] \qquad ( 36 )$$

Where X, Y, Z are the values of the pixel point in CIEXYZ color space, Rₗᵢₙₑₐᵣ, Gₗᵢₙₑₐᵣ, Bₗᵢₙₑₐᵣ are the RGB values of the pixel point after linearization.

Finally, values of the pixel points in the CIEXYZ color space are converted to CIELAB color space, that is:

$${L}^{*} = 116 \times f ( \frac{Y}{{Y}_{n}} ) - 16 \qquad ( 37 )$$

$${a}^{*} = 500 \times ( f ( \frac{X}{{X}_{n}} ) - f ( \frac{Y}{{Y}_{n}} ) ) \qquad ( 38 )$$

$${b}^{*} = 200 \times ( f ( \frac{Y}{{Y}_{n}} ) - f ( \frac{Z}{{Z}_{n}} ) ) \qquad ( 39 )$$

Where L*, a*, b* are the values of the pixel point in CIELAB color space, X, Y, Z are the values of the pixel point in CIEXYZ color space, Xₙ, Yₙ, Zₙ represent the XYZ values of the white point. If t>0.008856, f(t)=t^{1/3}, otherwise f(t)=16×t/903.3.

In step 2.2, the perceived lightness of the image is calculated according to the H-K effect.

Relevant experiments show that the lightness perceived by the human eye is determined by the physical lightness, chroma, and saturation in the color space. In the case of physical lightness, chroma remains unchanged, and more saturated colors will look brighter than less saturated colors, in the case of physical lightness, saturation remains unchanged, and different shades of color also produce different lightness differences, which is a more detailed expression of the Helmholtz-Kohlrausch effect (H-K effect).

To quantitatively characterize the H-K effect, this disclosure adopts the perceived lightness model proposed by Fairchild and Pirrotta. This perceived lightness model employs the CIELAB color space and represents the calculation of perceived lightness through a relatively simple formula. The calculation model of perceived lightness can be expressed as:

$$PL = {L}^{*} + ( 2.5 - 0.0 \; 25 {L}^{*} ) q ( h ) {C}^{*} \qquad ( 40 )$$

$$q ( h ) = 0.116 \vert sin ( \frac{h - 90}{2} ) \vert + 0. 085 \qquad ( 41 )$$

$${C}^{*} = \sqrt{{( {a}^{*} )}^{2} + {( {b}^{*} )}^{2}} \qquad ( 42 )$$

$$h = {tan}^{- 1} ( \frac{b}{{a}^{*}} ) \qquad ( 43 )$$

Where L*, a*, b* are the values of the pixel point in CIELAB color space, PL denotes the perceived lightness, and the difference between PL and L* is proportional to C* when L* and h are constant. Even if the lightness remains constant, the perceived lightness of the human eye decreases as the chromaticity decreases.

In step 2.3, based on the perceived lightness calculated in step 2.2, a relationship between the physical lightness and the perceived lightness is established, and a global lightness mapping is performed on the corrected image.

The perceived lightness calculation model is used to compute the perceived lightness of each pixel in the image to be mapped and the lightness reference image. Then, the perceived lightness means μ_{PL}^{ori}, μ_{PL}^{ref} and the standard deviations σ_{PL}^{oro}, σ_{PL}^{ref} for the image to be mapped and the lightness reference image are obtained by calculating, respectively. When a reference image is available, μ_{PL}^{ori}, σ_{PL}^{ref} correspond to the mean and standard deviation of the lightness reference image. When no reference image is available, μ_{PL}^{ref}, σ_{PL}^{ref} represent the average of the mean values and the average of the standard deviations of all the images to be mapped. The specific calculation formulas are as follows:

$$μ = \frac{{\sum }_{i = 1 , j = 1}^{I , J} {PL}_{ij}}{I \times J} \qquad ( 44 )$$

$$σ = \sqrt{\frac{{{Σ}_{i = 1 , j = 1}^{I , J} ( {PL}_{ij} - μ )}^{2}}{I \times J}} \qquad ( 45 )$$

Where, I, J denote the width and height of the image, PLᵢⱼ denotes the perceived lightness of the image.

The new lightness L_{new}* is obtained by global perceptual lightness mapping via the Wallis transformation, which is calculated as follows:

$${PL}_{res} = \frac{{σ}_{PL}^{ref}}{c {σ}_{PL}^{ori} + ( 1 - c ) {σ}_{PL}^{ref}} [ {PL}_{ori} - {μ}_{PL}^{ori} ] + b {μ}_{PL}^{ref} + ( 1 - b ) {μ}_{PL}^{ori} \qquad ( 46 )$$

$${L}_{new}^{*} = \frac{( {PL}_{res} - 2.5 q ( h ) {C}^{*} )}{( 1 - 0.0 \; 25 q ( h ) {C}^{*} )} \qquad ( 47 )$$

Where, PLᵣₑₛ is the perceived lightness of the pixel after mapping, PLₒᵣᵢ is the original perceived lightness of the pixel, b is the lightness coefficient, b∈(0,1); c is the variance expansion coefficient, c∈(0,1).

The image after lightness update is converted from CIELAB color space to RGB color space.

Based on the same inventive concept, this disclosure also provides a system of hue-distance constrained relative radiometric correction considering H-K effect for remote sensing images that takes into account the H-K effect, including a processor and a memory. The memory is used to store program instructions, and the processor is used to invoke the program instructions from the memory to execute the method of hue-distance constrained relative radiometric correction considering H-K effect for remote sensing images as described above.

Based on the same inventive concept, this disclosure also provides a system of hue-distance constrained relative radiometric correction considering H-K effect for remote sensing images, including a readable storage medium, on which a computer program is stored. When the computer program is executed, it implements the method of hue-distance constrained relative radiometric correction considering H-K effect for remote sensing images as described above.

The specific embodiments described herein are merely illustrative of the principles of this disclosure. Those skilled in the relevant technical field may make various modifications, additions, or adopt similar methods to replace the specific embodiments described, without departing from the spirit of this disclosure or exceeding the scope defined by the appended claims.

### Example

In one embodiment, for better explaining the patent, a number of multispectral images of GaoFen-2 satellite launched by China in August 2014 is used to present the workflow. The spatial resolution, shooting time, geographic location, and the number of images contained in each group of data are shown in Table 1.

TABLE 1
Corresponding table of the detailed image information

| | | | | | Number |
|---|---|---|---|---|---|
| | | Spatial | | Geographic | of |
| | Sensor type | resolution/m | Acquisition Time | location | images |
| Group1 | GF-2 PMS1 | 1 | 2018 April, 2018 June, | E126.4~E127.0 | 12 |
| | GF-2 PMS2 | | 2019 May, 2019 October | N50.3~N50.7 | |
| | | | 2020 September | | |
| Group2 | GF-2 PMS1 | 1 | 2018 April, 2018 June, | E126.3~E127.1 | 12 |
| | GF-2 PMS2 | | 2019 June, 2019 October | N49.6~N50.1 | |

A computing device, including an image storage and processing cluster (the cluster requires at least four servers, with each server acting as three nodes within the cluster. The server configuration requirements (minimum) are: memory: 8 GB, processor: Intel Core i7-7700 @ 3.6 GHz, hard drive: WDC WD 10EZEX-08WN4A0 1 TB 7200 rpm). When executed by the processor, the actions performed by the processor include: reading the remote sensing image to be processed into memory, performing relative radiometric correction according to the method of this disclosure, and then outputting the corrected image to memory. For understanding convenience, all images used in this paper were converted to 8-bit. In the example, the expansion constants c and the lightness coefficients b of the Wallis transform involved in all the methods are set to 1. And all the result images shown in the experiments are the corrected outputs without mosaicking.

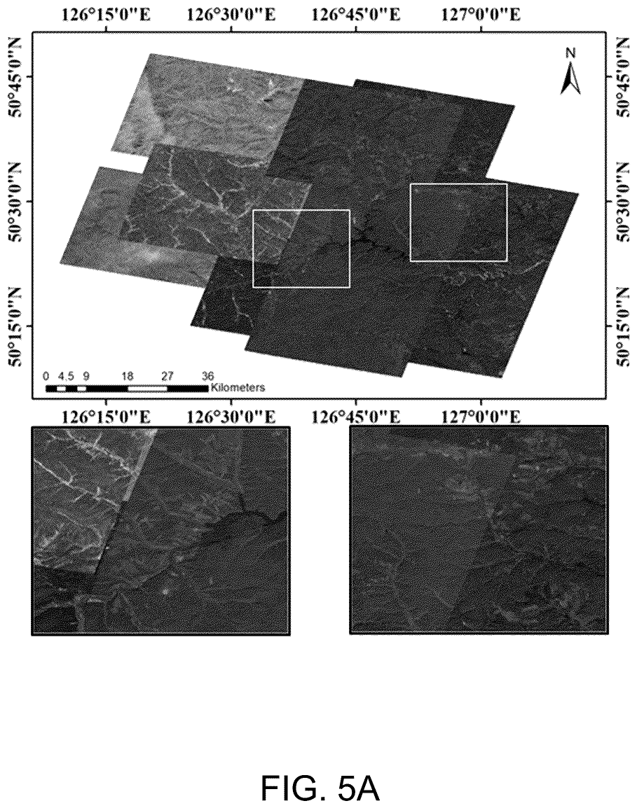

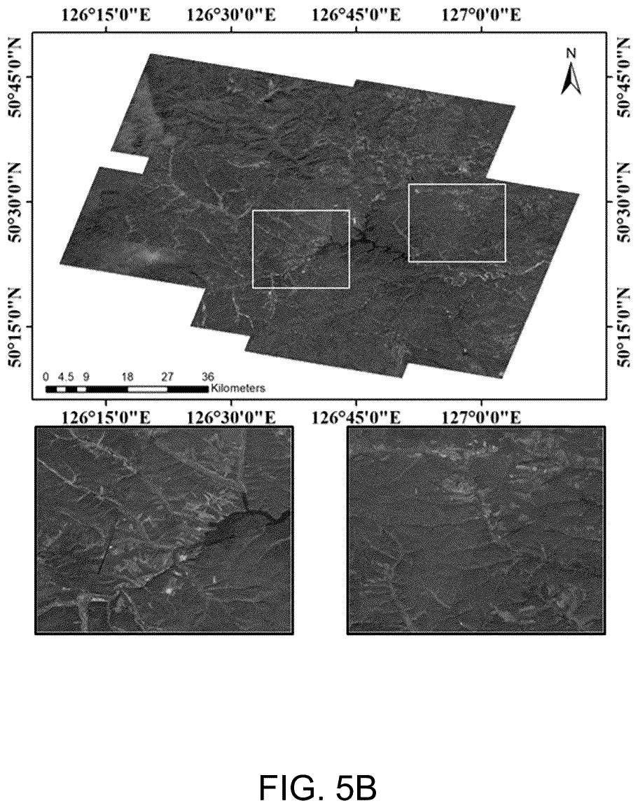

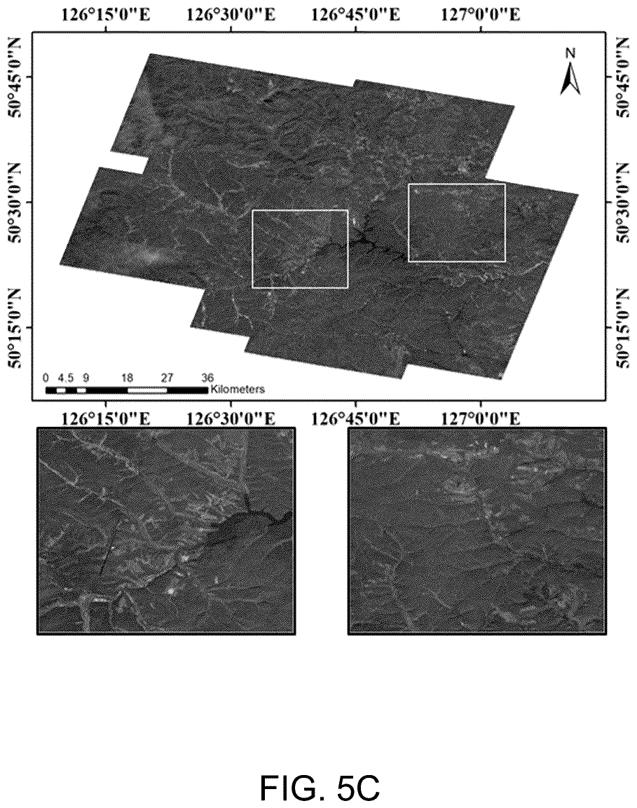

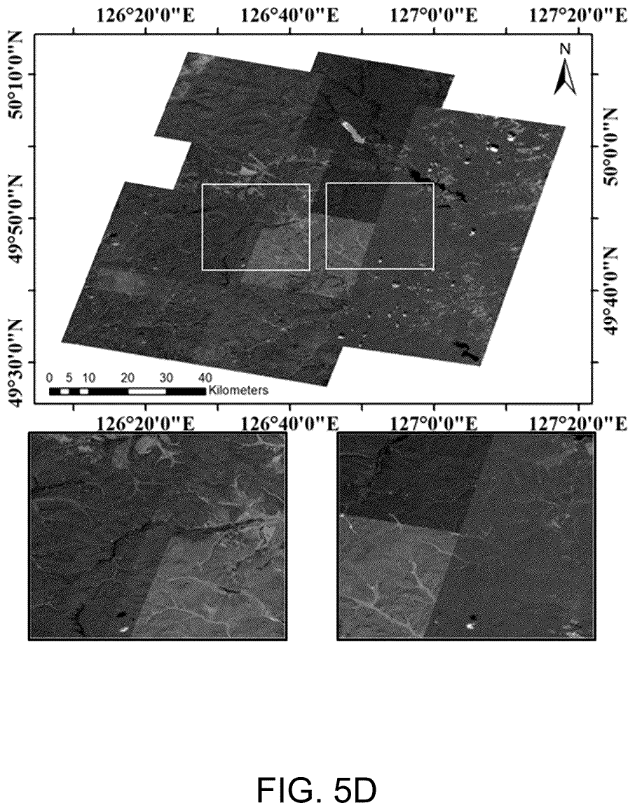

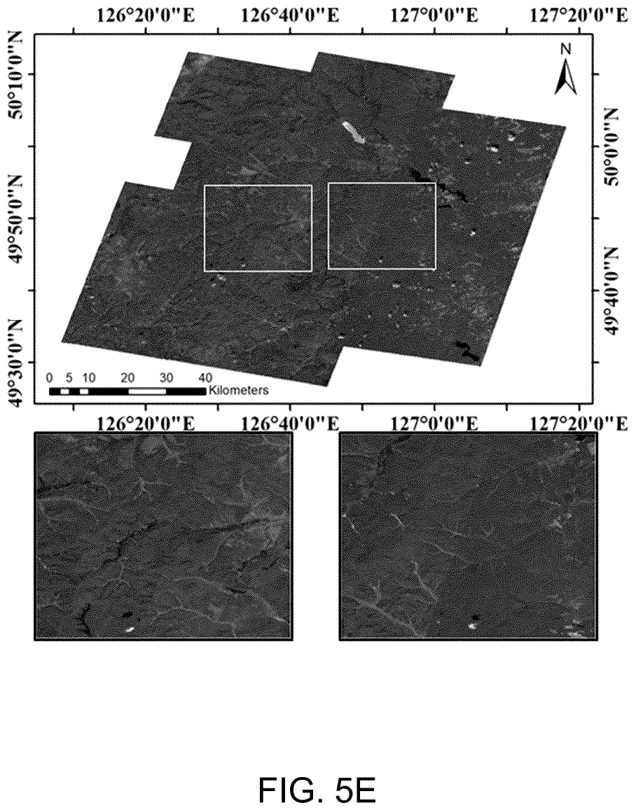

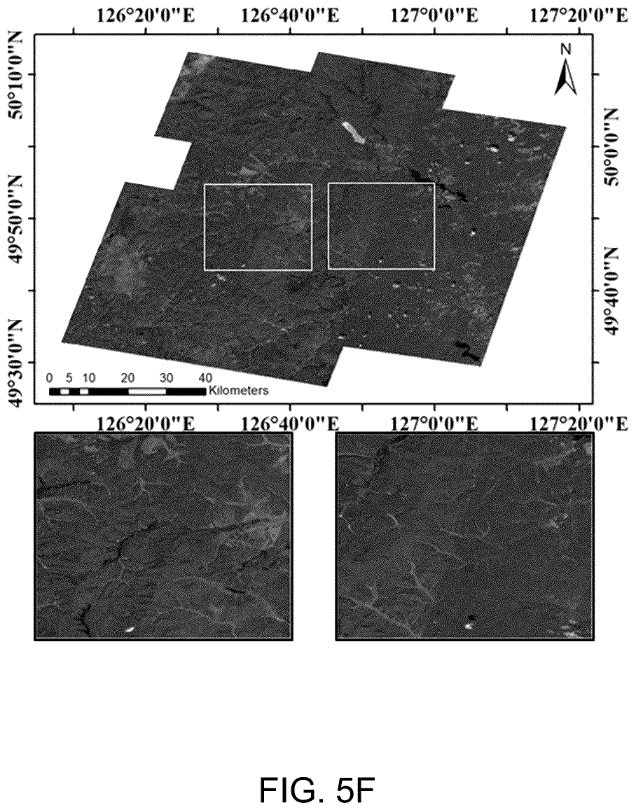

FIGS. 5A to 5F show the results of the visual assessment of the example for the correction workflow. Comparing the corrected images in FIG. 5B and FIG. 5E with the original images shown in FIG. 5A and FIG. 5D, it can be seen that the corrected images have a more balanced radiance and better visual effect on the whole. Based on the results, this paper carries out global lightness mapping to further optimize the results, FIGS. 5C, 5F and FIGS. 5B, 5E compared with the overall radiance has not changed too much, but the lightness of the image as a whole is more uniform, and the lightness of the local features is more consistent with the human eye's perception.

TABLE 2
Image quality evaluation before and after correction in Group1

| | | | Without | |
|---|---|---|---|---|
| | | | lightness | |
| | Band | Origin | mapping | Ours |
| SD | 1 | 9.7616 | 9.3023 | 9.3083 |
| | 2 | 5.8377 | 4.3499 | 4.1034 |
| | 3 | 6.8205 | 5.404 | 5.0062 |

| | | | |
|---|---|---|---|
| ΔE | 13.2622 | 11.6042 | 11.3377 |

TABLE 3
Image quality evaluation before and after correction in Group2

| | | | Without | |
|---|---|---|---|---|
| | | | lightness | |
| | Band | Origin | mapping | Ours |
| SD | 1 | 8.7500 | 8.6449 | 8.4145 |
| | 2 | 4.8899 | 3.3131 | 3.3488 |
| | 3 | 6.6903 | 4.2226 | 4.2008 |

| | | | |
|---|---|---|---|
| ΔE | 12.0513 | 10.1755 | 9.9832 |

The mean value reflects the overall tone of an image, the standard deviation (SD) is a commonly used evaluation metric to indicate the degree of dispersion of the data, with smaller values indicating greater data consistency, and is calculated pixel by pixel.

$$Mean = \frac{{\sum }_{i = 1 , j = I}^{1 ,} {p}_{i j}}{I * J} ; SD = \sqrt{\frac{{\sum }_{i = 1 , j = 1}^{I , J} {( {p}_{ij} - Mean )}^{2}}{I * J}} \qquad ( 48 )$$

I, J are the height and width of the image, p is the pixel value of a single band, and Mean denotes the average value of all pixels in that band.

ΔE is the basic unit for testing the human eye's perception of colour difference in a uniform color space. Since a reference image is not mandatory in the method proposed in this paper, we calculate the relative value of the ΔE.

$$Δ E = \sqrt{{( Δ {L}^{*} )}^{2} + {( Δ {a}^{*} )}^{2} + {( Δ {b}^{*} )}^{2}} \qquad ( 49 )$$

ΔL*, Δa*, Δb*represent the relative difference of the image in CIELAB color space, respectively.

It can also be seen from Table 2 and Table 3 that both radiance correction and lightness mapping play a positive role in the final resultant image, and although the change in SD before and after processing is relatively small, the effectiveness of the method proposed in this paper can be seen from the indicator ΔE.

It will be obvious to those skilled in the art that changes and modifications may be made, and therefore, the aim in the appended claims is to cover all such changes and modifications.

What is claimed is:

1. A method of hue-distance constrained relative radiometric correction considering Helmholtz-Kohlrausch (H-K) effect for remote sensing image, characterized by comprising following steps:
step 1, converting an image from a RGB color space to a CIELAB color space and performing a relative radiometric correction using an adaptive constraint based on hue-distance;
step 1.1, converting the image from the RGB color space to the CIELAB color space with luminance-chroma separation, decoupling of pixel radiometric values through transformation between color spaces to minimize channel correlation;
step 1.2, performing the relative radiometric correction using the adaptive constraint based on the hue-distance;
step 2, quantitatively describing the H-K effect and applying global lightness mapping to a corrected image;
step 2.1, converting the corrected image after relative radiometric correction into the CIELAB color space;
step 2.2, calculating perceived lightness of the image based on the H-K effect;
step 2.3, based on the perceived lightness calculated in step 2.2, establishing a relationship between physical lightness and the perceived lightness, and performing global lightness mapping on the corrected image.

2. The method according to claim 1, wherein in the step 1.1, RGB values of pixels are first converted to linear RGB values, then the linear RGB values are converted to a CIEXYZ color space, and finally values of pixel points in the CIEXYZ color space are converted to the CIELAB color space, specific conversion formula is as follows:
$$\begin{matrix}{R}_{linear} = {( \frac{R}{255} )}^{γ inverse} \\ {G}_{linear} = {( \frac{G}{255} )}^{γ inverse} \\ {B}_{linear} = {( \frac{B}{255} )}^{γ inverse}\end{matrix}$$
where R, G, B are the values of the pixel points in the RGB color space, Rₗᵢₙₑₐᵣ, Gₗᵢₙₑₐᵣ, Bₗᵢₙₑₐᵣ are the linear RGB values of the pixel points after linearization, γᵢₙᵥₑᵣₛₑ is an inverse operation of gamma correction, calculated as usual 2.2 gamma correction,
the linear RGB values are converted to the CIEXYZ color space as follows:
$$[ \begin{matrix}X \\ Y \\ Z\end{matrix} ] = [ \begin{matrix}0.4124564 & 0.3575761 & 0.1804375 \\ 0.2126729 & 0.7151522 & 0.072175 \\ 0.019339 & 0.119192 & 0.9503041\end{matrix} ] = \times [ \begin{matrix}{R}_{linear} \\ {G}_{linear} \\ {B}_{linear}\end{matrix} ]$$
where X, Y, Z are the values of the pixel points in the CIEXYZ color space, Rₗᵢₙₑₐᵣ, Gₗᵢₙₑₐᵣ, Bₗᵢₙₑₐᵣ are the linear RGB values of the pixel point after linearization,
XYZ values are converted to the CIELAB color space as follows:
$$\begin{matrix}{L}^{*} = 116 \times f ( \frac{Y}{{Y}_{n}} ) - 16 \\ {a}^{*} = 500 \times ( f ( \frac{X}{{X}_{n}} ) - f ( \frac{Y}{{Y}_{n}} ) ) \\ {b}^{*} = 200 \times ( f ( \frac{Y}{{Y}_{n}} ) - f ( \frac{Z}{{Z}_{n}} ) )\end{matrix}$$
where L*, a*, b* are the values of the pixel points in the CIELAB color space, X, Y, Z are the values of the pixel points in the CIEXYZ color space, Xₙ, Yₙ, Zₙ represent the XYZ values of the white point, if t>0.008856, f(t)=t^{1/3}, otherwise f(t)=16×t/903.3.

3. The method of claim 1, wherein in the step 1.2, the image converted to the CIELAB color space is pre-corrected once using the Wallis transformation,
$$wallis ( g ( x , y ) ) = \frac{{σ}_{t}}{c {σ}_{s} + ( 1 + c ) {σ}_{t}} [ g ( x , y ) - {μ}_{s} ] + b {μ}_{t} + ( 1 - b ) {μ}_{s}$$
where g(x, y) represents pixel grayscale values of the image to be processed after converting to the CIELAB color space; σₛ denotes a standard deviation of the pixel grayscale values in the image to be processed in the CIELAB color space; σₜ represents a standard deviation of the pixel grayscale values in an ideally corrected result image; μₛ refers to a mean grayscale value of the pixels in the image to be processed in the CIELAB color space; μₜ represents a mean grayscale value of the pixels in the ideally corrected result image; b is a luminance coefficient, where b∈(0,1); c is a variance expansion coefficient, where c∈(0,1); and wallis denotes the Wallis transform.

4. The method according to claim 3, wherein in the step 1.2, an image to be processed in the CIELAB color space and pre-corrected image are converted to a HSV color space, for each pixel to be processed, an initial hue h₀, an average hue of all pixels to be processed h̅₀̅, a result hue h₁ of each pre-corrected pixel, and an average hue of all pre-corrected pixels h̅₁̅ are calculated, hue values are expressed in degrees,
calculation is performed as follows:
$$h = \{ \begin{matrix}0 ° , else \\ 60 ° \times \frac{g - b}{max - min} , if max = r and g \geq b \\ 60 ° \times \frac{g - b}{max - min} + 360 ° , if max = r and g < b \\ 60 ° \times \frac{b - r}{max - min} + 120 ° , if max = g \\ 60 ° \times \frac{r - g}{max - min} + 120 ° , if max = b\end{matrix}$$
where h is a hue, (r, g, b) is r, g, b value of a corresponding pixel, max is a maximum value in (r, g, b) and min is a minimum value in (r, g, b).

5. The method according to claim 4, wherein in the step 1.2, a hue-distance Dₕ for each pixel before pre-correction and a hue-distance Dₕ′ for each pixel after pre-correction, if |Dₕ′−Dₕ| is lower than a set threshold of hue distance change, then a corresponding pixel is corrected using the adaptive constraint in the CIELAB color space and saved in RGB format,
$$\begin{matrix}{D}_{h} = {h}_{0} - \overline{h} \\ {D}_{h}^{′} = {h}_{1} - \overline{{h}_{1}}\end{matrix}$$
if |Dₕ′−Dₕ|≤ε, ε is the set threshold of hue distance change, then adaptive constraint correction is performed on the pixel in the CIELAB color space and saved in RGB format, and a specific formula for adaptive constraint correction is as follows:
$$Conwallis ( g ( x , y ) ) = \frac{{σ}_{t} \times \frac{ω {D}_{h}}{{D}_{h}^{′}}}{c {σ}_{s} + ( 1 - c ) {σ}_{t}} [ g ( x , y ) - {μ}_{s} ] + b {μ}_{t} - ( 1 - b ) {μ}_{s}$$
where g(x, y) represents grayscale values of the pixels in a pre-corrected result image; σₛ denotes a standard deviation of the pixel grayscale values in the pre-corrected result image; when a reference image is available, σₜ represents a standard deviation of the reference image; when no reference image is available, σₜ is an average standard deviation of all the pixels in the image to be processed; μₛ represents a mean grayscale value of the pixels in the pre-corrected result image; when a reference image is available, μₜ represents a mean value of the reference image; when no reference image is available, μₜ is an average mean value of all the pixels in the image to be processed; b is a luminance coefficient, where b∈(0,1); c is a variance expansion coefficient, where c∈(0,1); Conwallis represents a constrained Wallis transform; ω is a constraint coefficient; Dₕ represents a hue distance before pre-correction, and Dₕ′ represents a hue distance after pre-correction.

6. The method according to claim 2, wherein in the step 2.1, RGB image corrected by the adaptive constraint in step 1.2 is converted to the CIELAB color space, and a specific conversion method is the same as in step 1.1.

7. The method according to claim 1, wherein in step 2.2, a calculation model for the perceived lightness is built as follows:
$$\begin{matrix}PL = {L}^{*} + ( 2.5 - 0.0 \; 25 {L}^{*} ) q ( h ) {C}^{*} \\ q ( h ) = 0.116 \vert sin ( \frac{h - 90}{2} ) \vert + 0. 085 \\ {C}^{*} = \sqrt{{( {a}^{*} )}^{2} + {( {b}^{*} )}^{2}} \\ h = {tan}^{- 1} ( \frac{{b}^{*}}{{a}^{*}} )\end{matrix}$$
where L*, a*, b* are the values of the pixel points in the CIELAB color space, PL denotes perceived lightness and difference between PL and L* is proportional to C* when L* and h are constant, even if a lightness remains constant, the perceived lightness of a human eye decreases as a chromaticity decreases.

8. The method according to claim 7, wherein in step 2.3, the calculation model for the perceived lightness is used to compute the perceived lightness of each pixel in the image to be mapped and a lightness reference image, perceived lightness means μ_{PL}^{ori}, μ_{PL}^{ref} and standard deviations σ_{PL}^{ori}, σ_{PL}^{ref} for the image to be mapped and the lightness reference image are obtained by calculating, a new lightness L_{new}* is obtained by global lightness mapping via the Wallis transformation, and the image after lightness update is converted from CIELAB color space to the RGB color space,
a specific calculation formulas are as follows:
$$\begin{matrix}μ = \frac{{\sum }_{i = 1 , j = 1}^{I , J} {PL}_{ij}}{I \times J} \\ σ = \sqrt{\frac{{\sum }_{i = 1 , j = 1}^{I , J} {( {PL}_{ij} - μ )}^{2}}{I \times J}}\end{matrix}$$
where, I, J denote a width and a height of the image, PLᵢⱼ denotes the perceived lightness of the image.
$$\begin{matrix}{PL}_{res} = \frac{{σ}_{PL}^{ref}}{c {σ}_{PL}^{ori} + ( 1 - c ) {σ}_{PL}^{ref}} [ {PL}_{ori} - {μ}_{PL}^{ori} ] + b {μ}_{PL}^{ref} + ( 1 - b ) {μ}_{PL}^{ori} \\ {L}_{new}^{*} = \frac{( {PL}_{res} - 2.5 q ( h ) {C}^{*} )}{( 1 - 0.0 \; 25 q ( h ) {C}^{*} )}\end{matrix}$$
where, PLᵣₑₛ is the perceived lightness of the pixel after mapping, PLₒᵣᵢ is an original perceived lightness of the pixel, b is a lightness coefficient, b∈(0,1); c is a variance expansion coefficient, c∈(0,1).

9. A system of hue-distance constrained relative radiometric correction considering H-K effect for remote sensing images, characterized by comprising a processor and a memory, wherein the memory is configured to store program instructions, and the processor is configured to call the program instructions in the memory to execute the method of hue-distance constrained relative radiometric correction considering H-K effect for remote sensing images according to claim 1.

10. A system of hue-distance constrained relative radiometric correction considering H-K effect for remote sensing images, characterized by comprising a readable storage medium, wherein the readable storage medium has a computer program stored thereon, the computer program, when executed, realizes the method of hue-distance constrained relative radiometric correction considering H-K effect for remote sensing images according to claim 1.
